(19) United States
(12) Patent Application Publication
(10) Pub. No.: US 2025/0080182 A1
(43) Pub. Date: Mar. 6, 2025

(54) REFERENCE SIGNAL (RS) GRANT FOR AN ANTENNA MODULE WITH MULTIPLE STEERABLE BORESIGHT DIRECTIONS

(71) Applicant: QUALCOMM Incorporated, San Diego, CA (US)

(72) Inventors: Vasanthan RAGHAVAN, West Windsor Township, NJ (US); Sinan ADIBELLI, San Diego, CA (US); Junyi LI, Fairless Hills, PA (US); Mohammad Ali TASSOUDJI, San Diego, CA (US)

(21) Appl. No.: 18/462,250

(22) Filed: Sep. 6, 2023

(51) Int. Cl. H04B 7/06; H04L 5/00

(52) U.S. Cl. CPC H04B 7/0617; H04L 5/0048

(57) ABSTRACT

Certain aspects of the present disclosure provide a method for wireless communications at a user equipment (UE). The UE may transmit signaling indicating antenna module capability information including geometric shape information corresponding to one or more antenna modules of the UE. The geometric shape information is based on an availability of multiple boresight directions of the one or more antenna modules. The UE may receive an indication of a number of reference signals (RSs). The number of RSs is based on the antenna module capability information.

### BACKGROUND

### Field of the Disclosure

Aspects of the present disclosure relate to wireless communications, and more particularly, to techniques for grant of reference signals (RSs) for beam management.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes transmitting signaling indicating antenna module capability information comprising geometric shape information corresponding to one or more antenna modules of the UE, wherein the geometric shape information is based on an availability of multiple boresight directions of the one or more antenna modules; and receiving an indication of a number of reference signals (RSs), wherein the number of RSs is based on the antenna module capability information.

Another aspect provides a method for wireless communications at a network entity. The method includes receiving signaling indicating antenna module capability information comprising geometric shape information corresponding to one or more antenna modules of a UE, wherein the geometric shape information is based on an availability of multiple boresight directions of the one or more antenna modules; and transmitting an indication of a number of RSs, wherein the number of RSs is based on the antenna module capability information.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5A, FIG. 5B, FIG. 5C, and FIG. 5D depict different antenna modules.

FIG. 6 depicts example structure of a double L shaped antenna module.

FIG. 7 and FIG. 8 depict example portions of a UE including a double L shaped antenna module.

FIG. 9 and FIG. 10 depict example array gains for different antenna modules.

FIG. 11 depicts a call flow diagram illustrating example communication among a UE and a network entity.

FIG. 12 depicts a method for wireless communications at a UE.

FIG. 13 depicts a method for wireless communications at a network entity.

FIG. 14 and FIG. 15 depict example communications devices.

### DETAILED DESCRIPTION

Aspects of the present disclosure provide apparatuses, methods, processing systems, and computer-readable mediums for grant of reference signals (RSs) or beams for beam management (e.g., based on detection or inference of a geometry of an antenna module that corresponds to multiple independent steerable boresight directions).

In millimeter wave (mmW) systems, beamforming technologies are used to increase an array gain and hence signal strength. Increases in the array gain may improve the quality of signal transmission and reception. In some cases, devices such as user equipments (UEs) and gNodeBs (gNBs) using wireless communication technologies may include multiple antenna modules. Each antenna module may include one or more transmission and reception antennas, antenna elements or antenna arrays that can be co-phased and are configured to transmit and receive communications over one or more spatial streams/layers with a beamformed transmission over said spatial streams/layers. To train for beamforming at a UE, a UE receive (Rx) beam sweep may be performed, to help select an optimal beam from a set of different Rx beams. The beamforming may also improve a signal-to-noise ratio (SNR) of received signals, eliminate undesirable interference sources, and focus transmitted signals to specific locations.

A channel between a UE and a gNB may be characterized by multiple clusters corresponding to reflections or scattering from physical objects in the channel environment. Since azimuth angle of arrival (AOA) and zenith angle of arrival (ZOA) of signals from the clusters are expected to be from any direction at the UE side in a downlink setting (e.g., due to ground bounces, reflections from different objects, etc.), array gain metrics for an antenna module of the UE may include an array gain over a sphere around the UE. This is referred to as a spherical coverage of effective isotropic radiated power (EIRP) and/or effective isotropic sensitivity (EIS) in either a transmit mode operation or a receive mode operation at the UE side.

Antenna modules may be in various configurations. For example, an antenna module may include a linear antenna array. The linear antenna array is able to steer energy along a single boresight direction. To realize spherical coverage objectives for the UE (e.g., corresponding to gNB level requirements), additional directional coverage of the energy (i.e., more than one boresight direction) is required. The additional directional coverage of the energy can be achieved by using multiple linear antenna arrays placed at different parts of the UE. However, the use of multiple linear antenna arrays at the UE can significantly increase cost as these antenna arrays have to be controlled by independent antenna modules. To reduce the cost, an antenna module that covers multiple boresight directions (i.e., an antenna module with antennas or antenna elements pointing towards multiple directions) can be used at the UE, which may provide the additional directional coverage of the energy. Antenna modules with multiple boresight directions may include a double L shaped antenna module (e.g., associated with three independent boresight directions) or an L or a T shaped antenna module (e.g., associated with two independent boresight direction). The double L shaped antenna module is able to provide a better spherical coverage performance especially at tails (e.g., relative to other shapes/configurations) due to its capability to steer energy in the multiple boresight directions.

Currently, how different UE antenna modules (e.g., the double L shaped antenna module) are designed is UE-level implementation specific. Typically, the UE does not have to report any antenna information associated with its antenna modules (or their properties) to the gNB, even though this information could be useful for beam management.

Currently, a gNB may allocate and configure a fixed number of RSs for the UE for beamforming. The gNB may determine the fixed number of RSs to be allocated to the UE, based on a static codebook of beams. When the allocation of the RSs to the UE is not based on the antenna modules of the UE, an array gain corresponding to the antenna modules (e.g., the double L shaped antenna module) of the UE may be low. For example, a high array gain based on combining signals across multiple sides of the double L shaped antenna module cannot be realized by the fixed number of RSs (e.g., as there is a need for adaptive/dynamic beam weights to combine the signals across the multiple sides of the double L shaped antenna module). The low array gain of the double L shaped antenna module of the UE may result in a lower signal strength (e.g., a reference signal received power (RSRP) or similar metrics), which may decrease communication reliability between the UE and the gNB.

Techniques proposed herein may enable a gNB to dynamically allocate and configure RSs for a UE to help enhance beamformed communications, based on antenna information regarding antenna modules of the UE. For example, the UE may transmit the antenna information indicating capability of the UE on simultaneous “steerability” of energy in multiple boresight directions. The antenna information may include a number of boresight directions (e.g., associated with each antenna module of the UE) as well as their relative orientations. Based on the antenna information, the gNB configures and grants UE-specific RSs for adaptive and/or dynamic beam weight learning, to enable combining of signals across some or all antenna elements across different boresight directions. This may enhance array gain performance of the antenna modules (e.g., a double L shaped antenna module) of the UE.

Particular aspects of the subject matter described in this disclosure can be implemented to realize one or more of the following potential advantages. In some examples, the described techniques can lead to a higher array gain corresponding to the different antenna modules for the UE. The higher array gain may result in a higher signal strength, which may increase communication reliability and lead to better performance.

Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

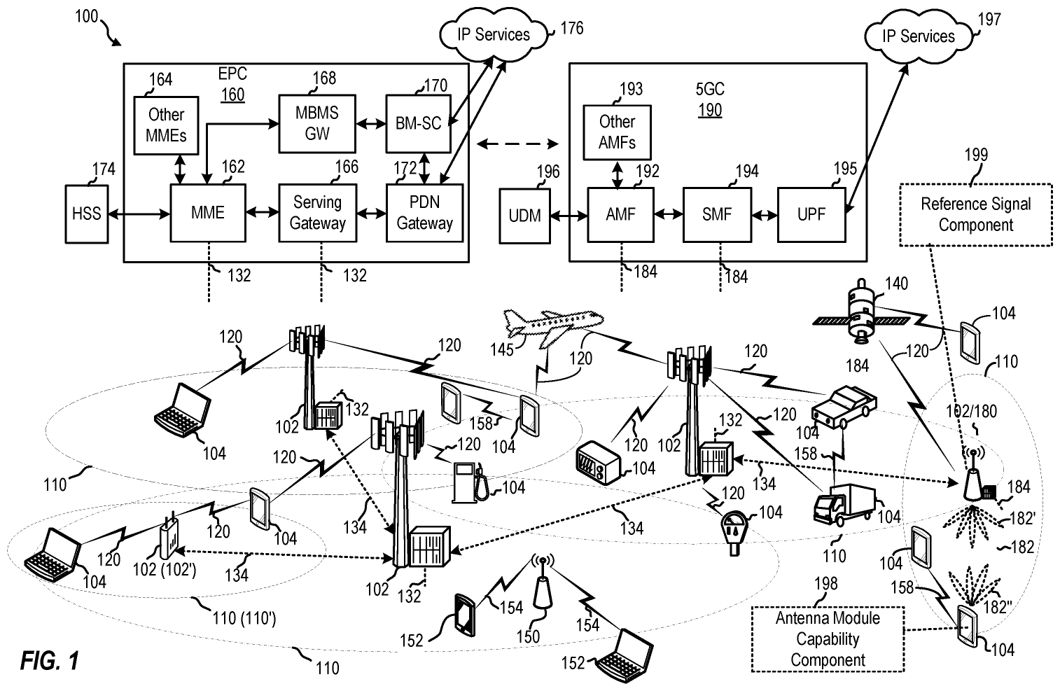

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

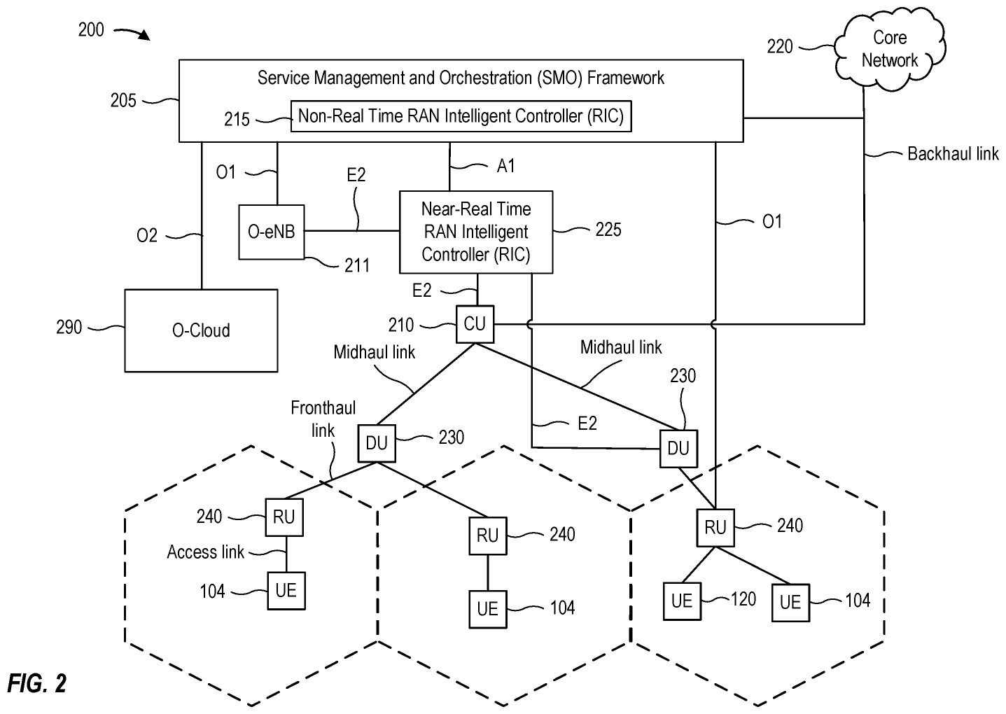

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (Rus), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6GHz, which is often referred to (interchangeably) as “Sub-6 GHz”. Similarly, 3GPP currently defines Frequency Range 2 (FR2) as including 26-41 GHZ, which is sometimes referred to (interchangeably) as a “millimeter wave” (“mmW” or “mmWave”). A BS configured to communicate using mm Wave/near mm Wave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

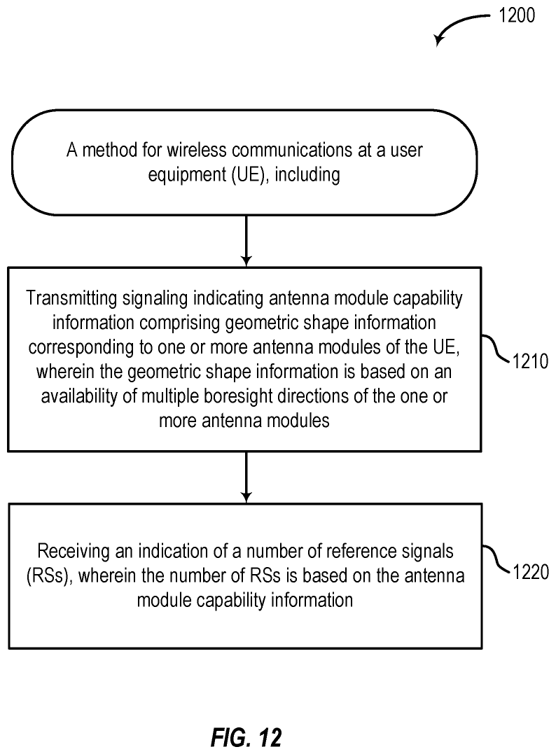

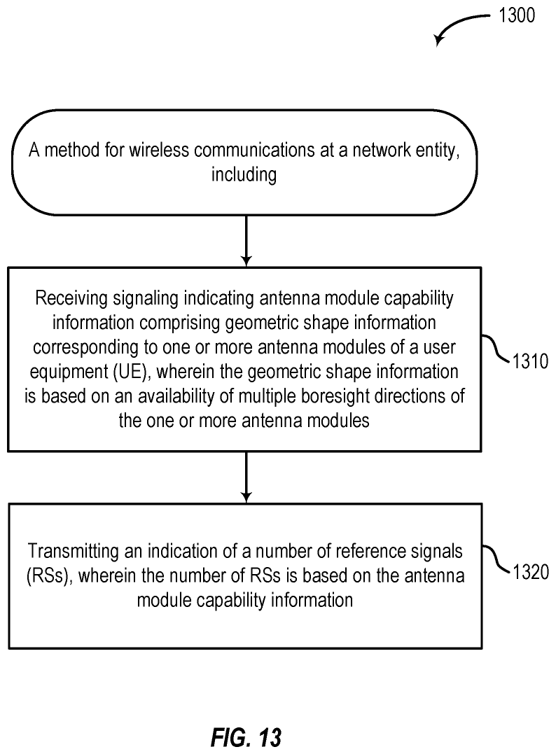

Wireless communication network 100 further includes antenna module capability component 198, which may be configured to perform method 1200 of FIG. 12. Wireless communication network 100 further includes reference signal component 199. which may be configured to perform method 1300 of FIG. 13.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (Cus) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

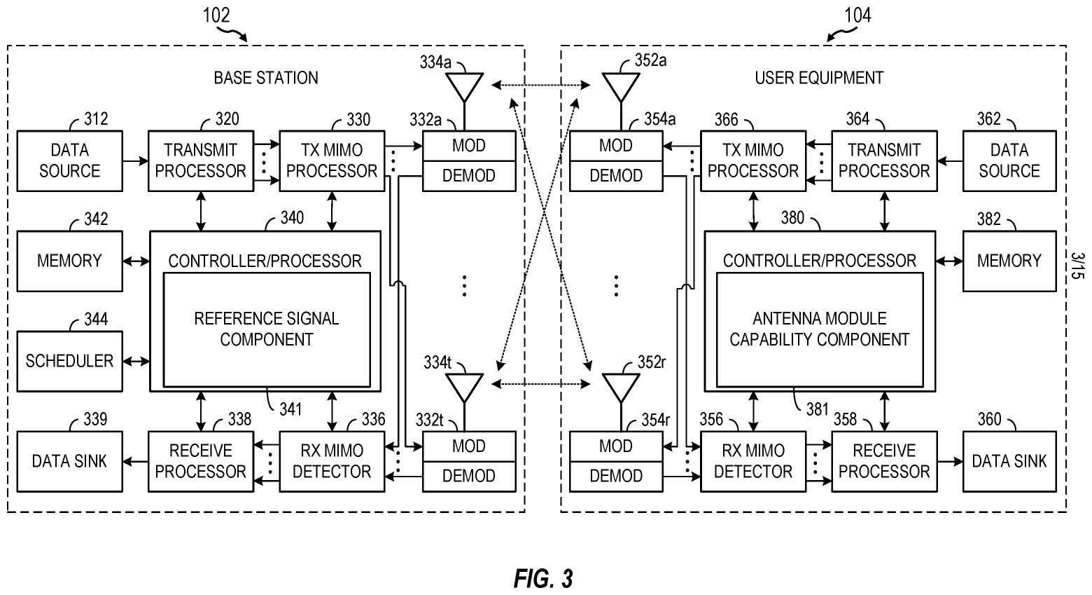

FIG. 3 depicts aspects of an example BS 102 and a UE 104.

Generally, BS 102 includes various processors (e.g., 320, 330, 338, and 340). antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes reference signal component 341, which may be representative of reference signal component 199 of FIG. 1. Notably, while depicted as an aspect of controller/processor 340, reference signal component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes antenna module capability component 381, which may be representative of antenna module capability component 198 of FIG. 1. Notably, while depicted as an aspect of controller/processor 380, antenna module capability component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

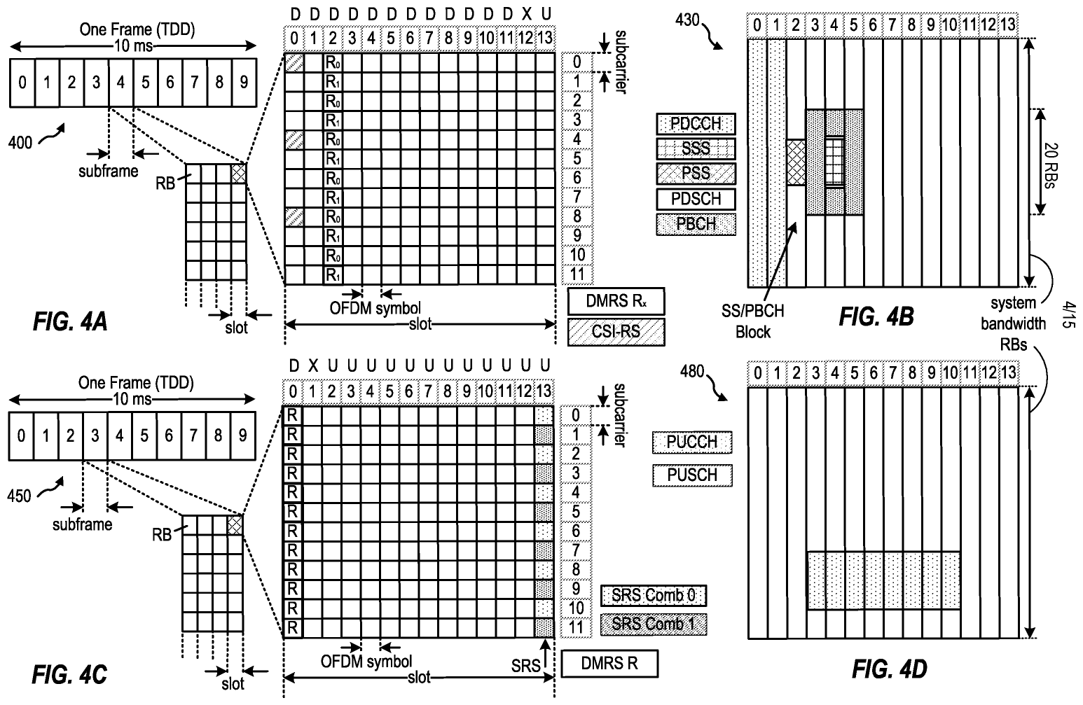

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there arc 14 symbols/slot and 2μ slots/subframe. The subcarrier spacing and symbol length/duration are a function of the numerology. The subcarrier spacing may be equal to 24×15 kHz, where μ is the numerology 0 to 5. As such, the numerology μ=0 has a subcarrier spacing of 15 kHz and the numerology μ=5 has a subcarrier spacing of 480kHz. The symbol length/duration is inversely related to the subcarrier spacing. FIG. 4A, FIG. 4B. FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mm Wave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101-2 currently defines Frequency Range 2-1 (FR2-1) as including 24.25-52.6 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Beamforming

In millimeter wave (mmW) systems, beamforming technologies are used to increase array gain. For example, devices such as user equipments (UEs) and network entities (e.g., a gNodeB (gNB)) using wireless communication technologies may include multiple antenna arrays. Each antenna array may include one or more transmission and reception antennas that can be co-phased and are configured to transmit and receive communications over one or more spatial streams/layers. The use of the multiple antenna arrays may afford the ability to meet spherical coverage requirements with/without hand/body blockage as well as robustness with beam switching over the antenna arrays.

Increases in the array gain facilitate a better quality of signal transmission and reception. To provide the array gain in a particular direction, beamforming is considered. Beamforming is a technique that utilizes advanced antenna technologies on both UEs and gNBs to focus a wireless signal according to a set of beam weights (e.g., in a specific direction), rather than broadcasting to a wide area. For beamforming at a UE, it usually includes a UE receive (Rx) beam sweep from a set of different beams. Beamforming may improve signal-to-noise ratio (SNR) of received signals, eliminate undesirable interference sources, and focus the transmitted signals to specific locations.

Beamforming is also performed to establish a link between the gNB and the UE, where both these devices form a beam directed towards (but not limited to this possibility) each other. For example, both the gNB and the UE find at least one adequate beam to form a communication link between each other. gNB-beam and UE-beam form what is known as a beam pair link (BPL). As an example, on a downlink (DL), the gNB uses a transmit beam and the UE uses a receive beam corresponding to the transmit beam to receive a DL transmission. The combination of the transmit beam and the corresponding receive beam is the BPL.

### Overview of Spherical Coverage

A channel between a user equipment (UE) and a network entity (e.g., a gNodeB (gNB)) may be characterized by multiple clusters with each cluster corresponding to a reflection or scattering of signals from the gNB to the UE via a physical object (e.g., vehicles, humans, glass/metallic objects, etc.). Azimuth angle of arrival (AOA) and zenith angle of arrival (ZOA) of signals for each of the cluster as seen at the UE side can be along any direction (e.g., due to ground bounces, reflections from different objects, etc.). Since the AOA and the ZOA of the signals are expected to be from any direction at the UE side, good array gain metrics for a UE may include a good coverage of the array gain over a sphere around the UE. This is called as a spherical coverage of effective isotropic radiated power (EIRP) and/or effective isotropic sensitivity (EIS).

EIRP is a measurement of the radiated output power from an equivalent isotropic antenna in a single direction. The isotropic antenna is meant to distribute power equally in all directions. When the power of the isotropic antenna is channeled in the single direction, the power radiated in that single direction can be substantially higher leading to an increased EIRP value. In antenna measurements, measured sensitivity over each angle is called the EIS of an antenna in that direction. Similar to the EIRP, the EIS can show a significantly altered/reduced value in some directions corresponding to the channeling of energy along a single direction by a non-isotropic antenna.

The performance over a sphere around the UE may be specified by a cumulative distribution function (CDF) of the EIRP and/or the EIS over the sphere (called as the spherical coverage metric), which is a combination of a transmitted power and the array gain. An upper bound to the spherical coverage may be based on electric field (E-field) radiation data of antennas of one or more antenna arrays of an antenna module, and is computed assuming maximum ratio combining (MRC) of the antennas of the one or more antenna arrays.

Spherical coverage objectives for the UE may be specified in terms of a peak performance (e.g., a peak array gain) and different percentile levels (e.g., 20^{th}, 50^{th}, 80^{th} percentile levels) of the EIRP/EIS over the sphere around the UE at different frequencies and/or bands.

### Overview of Antenna Modules

A user equipment (UE) or other device may include an antenna module, which further includes one or more antenna arrays having a set of antennas or antenna elements. The antenna module may include or is a linear antenna array or a planar antenna array. The antenna module may be a L shaped antenna module, a double L shaped antenna module, a T shaped antenna module, or any other shape antenna module.

In some cases, antenna polarization can be indicated via a direction in which an electric field of a radio wave oscillates while it propagates through a medium. A point of reference for specifying a polarization is looking at it from a transmitter of a signal. This can be visualized by imagining standing directly behind an antenna module or an antenna array, and looking in the direction it is aimed. In the case of a horizontal polarization (H), the electric field will move sideways in a horizontal plane. That is, an electric field vector of electro-magnetic wave is parallel to the earth. This is generated by having antenna modules or antenna arrays horizontal to the earth. For vertical polarization (V), the electric field is illustrated as oscillating up and down in a vertical plane. That is, the electric field vector of the electro-magnetic wave is perpendicular to the earth. This is generated by having the antenna modules or the antenna arrays vertical to the earth.

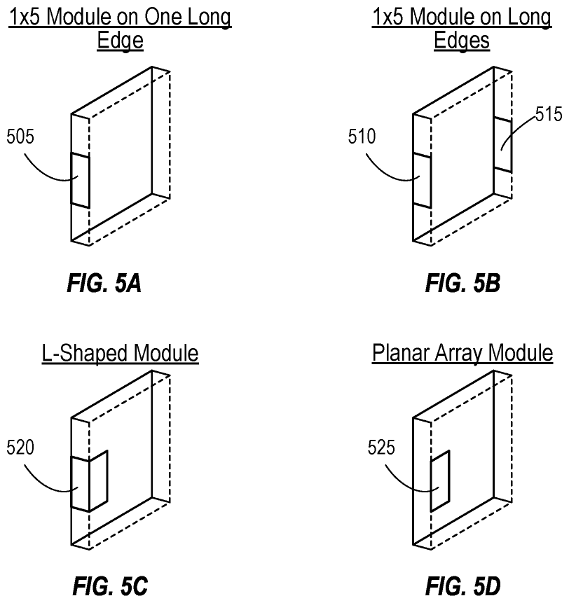

As depicted in FIG. 5A, a UE includes a first antenna module 505 on one side (or a long edge) of the UE. The first antenna module 505 may include or is a 1×5 linear antenna array. The linear antenna array may include one or more antenna elements, and is able to steer energy along a single boresight direction. In some cases, multiple antenna modules may be placed on a single long edge or side of the UE. For example, the UE may include two antenna modules on one edge or side of the UE.

In some cases, a higher number of antenna elements in a given direction in an antenna array or antenna module (e.g., the first antenna module 505) increases peak array gain in the said direction. However, more antenna elements steered along different directions of the antenna array or the antenna module increases antenna coverage across different directions (e.g., with lower percentile levels of effective isotropic radiated power (EIRP) and/or effective isotropic sensitivity (EIS) over a sphere around the UE). Accordingly, there is a tension between peak antenna gain requirements and lower percentile EIRP/EIS requirements.

In some cases, to realize spherical coverage objectives for the UE at the middle and lower percentile points, additional directional coverage of the energy (i.e., more than one boresight direction) is required than provided by the linear antenna array. The additional directional coverage of the energy can be achieved by using multiple antenna modules (e.g., including the linear antenna arrays) at the UE. For example, the UE may be equipped with the multiple antenna modules on multiple edges or sides of the UE for the additional directional coverage of the energy.

As depicted in FIG. 5B, a UE includes a first antenna module 510 on a first side/edge of the UE and a second antenna module 515 on a second side/edge of the UE. Each of these antenna modules may include or is a linear antenna array, and be able to steer energy along an independent boresight direction. In some cases, the multiple antenna modules may be placed on each side of the UE. For example, the UE may include two antenna modules on each side of the UE.

In some cases, the use of the multiple antenna modules at the UE can significantly increase cost. To reduce cost, a single antenna module that covers multiple boresight directions (i.e., an antenna module with antennas or antenna elements pointing towards multiple directions) can be used at the UE, which may provide the additional directional coverage of the energy. The antenna module with the multiple boresight directions may include a L shaped antenna module, a double L shaped antenna module, a planar structured antenna module, etc.

As depicted in FIG. 5C, a UE includes a L shaped antenna module 520 on an edge or a side of the UE. The L shaped antenna module 520 is associated with two independent boresight directions (e.g., along X and Z axes). For example, a first antenna array of the L shaped antenna module is associated with a first boresight direction and a second antenna array of the L shaped antenna module is associated with a second boresight direction.

As depicted in FIG. 5D, a UE includes a first antenna module 525 on one side of the UE. The first antenna module 525 may include or is a planar antenna array. The planar antenna array is able to steer energy along one or more boresight directions.

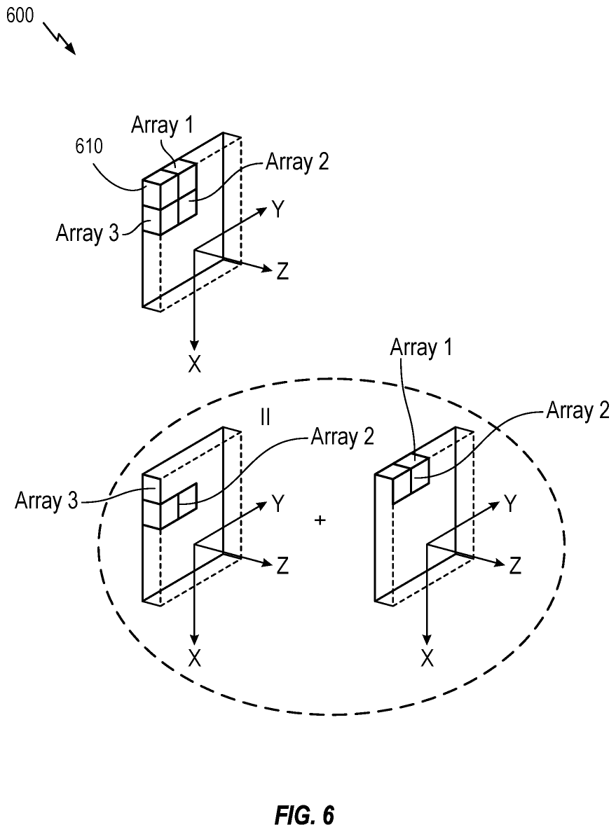

FIG. 6 depicts a diagram 600 of a double L shaped antenna module 610 on an edge or a side of a UE. The double L shaped antenna module 610 includes multiple antenna arrays (e.g., three antenna arrays). That is, the multiple antenna arrays are combined or arranged together to form the double L shaped antenna module 610.

The double L shaped antenna module 610 is associated with three independent boresight directions (e.g., along X, Y and Z axes). A first antenna array (e.g., depicted as array 1 in FIG. 6) of the double L shaped antenna module 610 is associated with a first boresight direction. For example, the first antenna array may scan XY plane (e.g., boresight of-X axis). A second antenna array (e.g., depicted as array 2 in FIG. 6) of the double L shaped antenna module 610 is associated with a second boresight direction. For example, the second antenna array may scan XZ and YZ planes (e.g., boresight of Z axis). A third antenna array (e.g., depicted as array 3 in FIG. 6) of the double L shaped antenna module 610 is associated with a third boresight direction. For example, the third antenna array may scan XY plane (e.g., boresight of-Y axis).

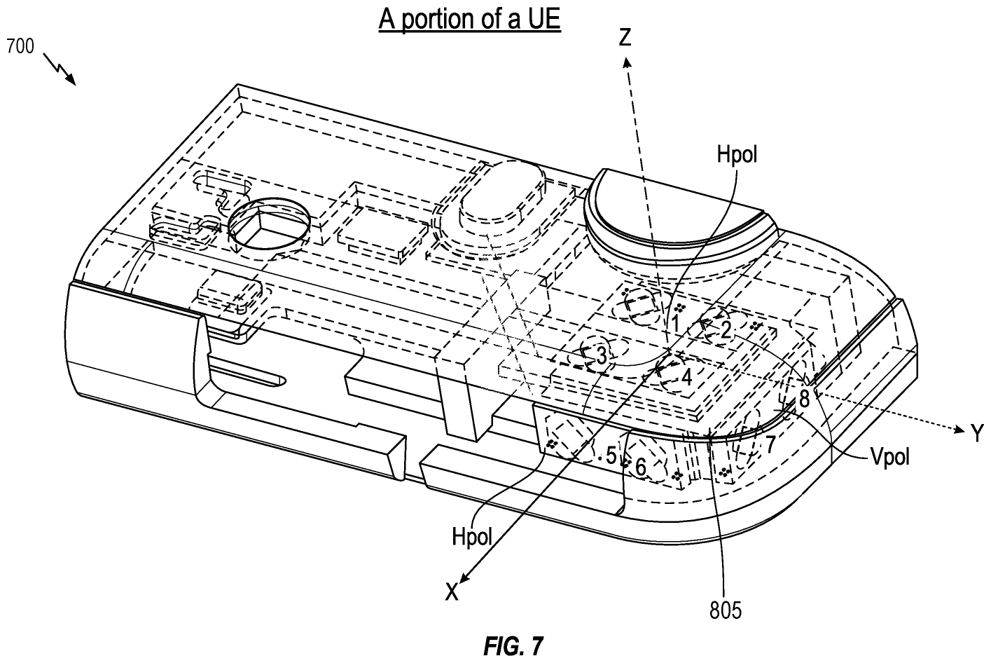

FIG. 7 depicts a diagram 700 of a portion of a UE including a double L shaped antenna module (such as the double L shaped antenna module 610 of FIG. 6). The double L shaped antenna module covers multiple boresight directions (e.g., along -X, -Y and Z axes).

The double L shaped antenna module may support eight antenna feeds per polarization (e.g., fully utilizing a radio frequency integrated circuit (RFIC) device feed capability).

The double L shaped antenna module can be used in two modes of operation. In one example mode (such as uncombined mode), optimal antenna arrays or a best of 2×2, 2×1, and 1×2 antenna arrays of the double L shaped antenna module are selected for the operation. In another example mode (such as combined mode), optimal antenna elements or a best of all antenna elements of the double L shaped antenna module that are appropriately co-phased are selected for the operation.

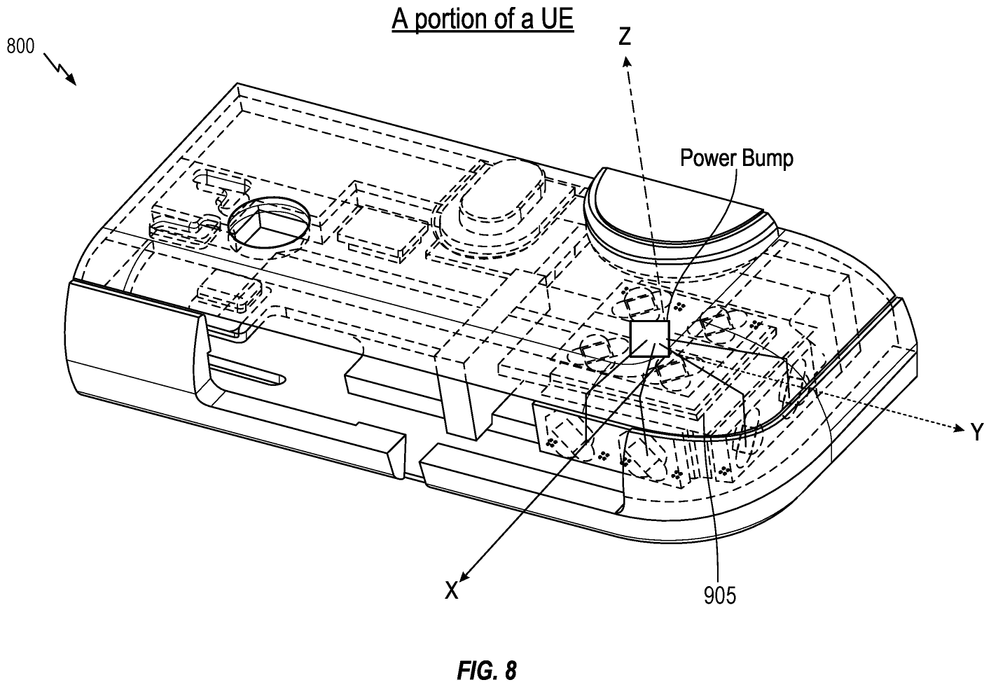

FIG. 8 depicts another diagram 800 of a portion of a UE including a double L shaped antenna module (such as the double L shaped antenna module 610 of FIG. 6). As depicted, a power bump indicates a source of power for an RFIC device which manages the double L shaped antenna module. The RFIC device is associated with an RFIC connector.

In some cases, an RFIC device associated with one or more antenna modules of the UE (e.g., a L shaped antenna module that covers two independent boresight directions, a double L shaped antenna module that covers three independent boresight directions, etc.) may control a number of antenna feeds. In some cases, when a total number of antenna feeds controlled by the RFIC device may remain same in both the L shaped antenna module and the double L shaped antenna module, a number of antennas steering peak energy towards each boresight direction is smaller/comparable in the double L shaped antenna module relative to the L shaped antenna module. That is, more boresight directions can be covered with the double L shaped antenna module than the L shaped antenna module, at the cost of a peak array gain in each boresight direction. In some cases, during operation of the double L shaped antenna module, a feedline loss (e.g., of 1 decibel (dB) on average per antenna element) is assumed/incurred as feedlines may cross a flex structure.

Accordingly, broader tradeoffs between the L shaped antenna module and the double L shaped antenna module may include better spherical coverage for more boresight directions (e.g., in the double L shaped antenna module due to its capability to steer energy in multiple boresight directions) and increased peak array gain in each boresight direction (e.g., in the L shaped antenna module). These tradeoffs affect spherical coverage performance in different ways. For example, the spherical coverage performance at middle percentile points may be improved by using the double L shaped antenna module whereas the spherical coverage performance at peak percentile points may be improved by using the L shaped antenna module.

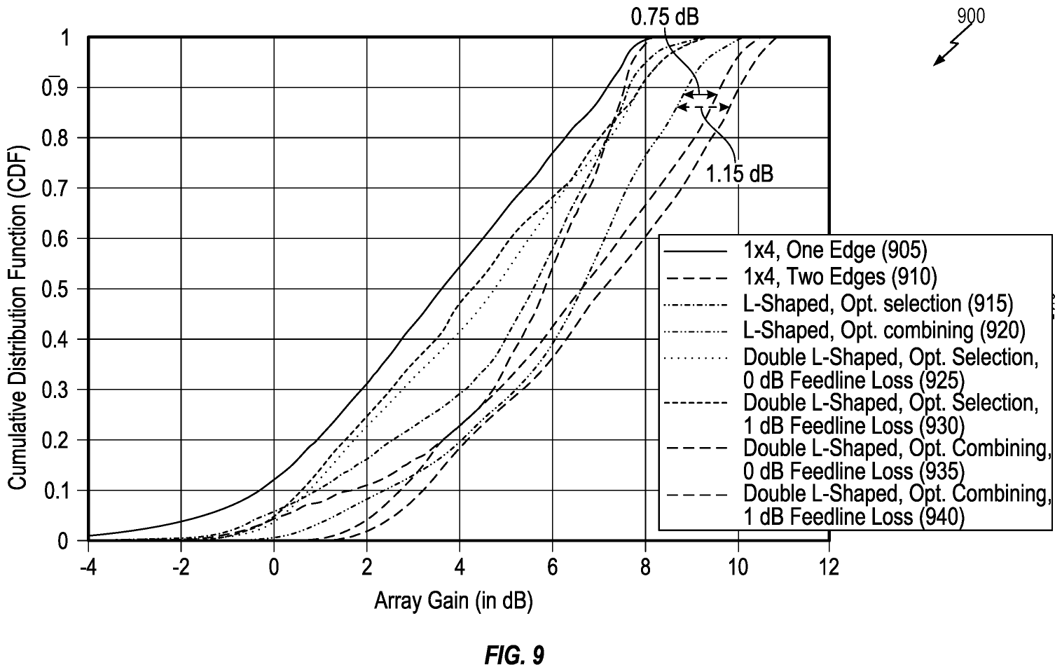

FIG. 9 depicts a diagram 900 showing array gains (directivity) for different antenna modules (including antenna arrays with antennas or antenna elements) of a UE. The antenna modules provide a spherical coverage over the UE.

The diagram 900 includes the array gains of a first antenna module (e.g., with a 1×4 linear antenna array on its one edge/side) 905, a second antenna module (e.g., with a 1×4 linear antenna array on its two edges/sides) 910, a third antenna module (e.g., a L shaped antenna module with an optimal selection of some of its antenna elements and/or antenna arrays) 915, a fourth antenna module (e.g., a L shaped antenna module with an optimal combination of all of its antenna elements and/or antenna arrays) 920, a fifth antenna module (e.g., a double L shaped antenna module with an optimal selection of some of its antenna elements and/or antenna arrays, and 0 dB feedline loss for antenna elements) 925, a sixth antenna module (e.g., a double L shaped antenna module with an optimal selection of some of its antenna elements and/or antenna arrays, and 1 dB feedline loss for antenna elements) 930, a seventh antenna module (e.g., a double L shaped antenna module with an optimal combination of all of its antenna elements and/or antenna arrays, and 0 dB feedline loss for antenna elements) 935, and an eighth antenna module (e.g., a double L shaped antenna module with an optimal combination of all of its antenna elements and/or antenna arrays, and 1 dB feedline loss for antenna elements) 940.

As depicted in FIG. 9, performance of double L shaped antenna modules (e.g., with an optimal combination of all of its antenna elements and/or antenna arrays, and an optimal and unconstrained polarization of its antenna elements and/or antenna arrays) is much better than one 1×4 or two 1×4 antenna arrays. For example, the array gain of the seventh antenna module 935 and the eighth antenna module 940 is much higher than other antenna modules such as the first antenna module 905 and the second antenna module 910. This may be because energy across different sides of the seventh antenna module 935 and the eighth antenna module 940 is being combined.

As further depicted in FIG. 9, performance of double L shaped antenna modules (e.g., with an optimal selection of some of its antenna elements and/or antenna arrays) is similar to L shaped antenna modules (e.g., with an optimal selection of some of its antenna elements and/or antenna arrays). For example, the array gain of the fifth antenna module 925 and the sixth antenna module 930 is similar to the array gain of the third antenna module 915.

As further depicted in FIG. 9, performance of double L shaped antenna modules (e.g., with an optimal combination of all of its antenna elements and/or antenna arrays, and an optimal and unconstrained polarization of its antenna elements and/or antenna arrays) is better than L shaped antenna modules (e.g., with an optimal combination of all of its antenna elements and/or antenna arrays, and an optimal and unconstrained polarization of its antenna elements and/or antenna arrays). For example, the array gain of the eighth antenna module 940 is better than the array gain of the fourth antenna module 920 (e.g., by ˜0.75 dB with a 1 dB feedline loss for antenna elements).

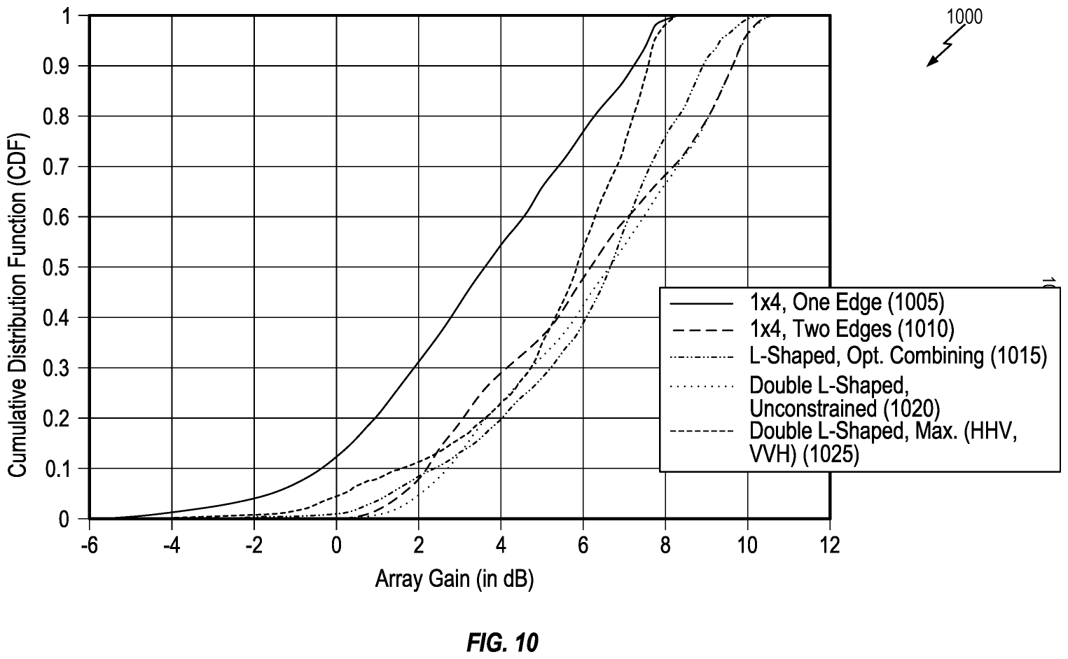

FIG. 10 depicts a diagram 1000 showing array gains (directivity) for different antenna modules (including antenna arrays with antennas or antenna elements) of a UE.

The diagram 1000 includes the array gains of a first antenna module (e.g., with a 1×4 linear antenna array on its one edge/side) 1005, a second antenna module (e.g., with a 1×4 linear antenna array on its two edges/sides) 1010, a third antenna module (e.g., a L shaped antenna module with an optimal combination of all of its antenna elements and/or antenna arrays) 1015, a fourth antenna module (e.g., a double L shaped antenna module with an optimal and unconstrained polarization of its antenna elements and/or antenna arrays) 1020, and a fifth antenna module (e.g., a double L shaped antenna module with a fixed polarization of its antenna elements and/or antenna arrays) 1025.

The fourth and fifth antenna modules 1020, 1025 may include 2×2, 2×1, and 1×2 antenna arrays. Each of these three antenna arrays may be associated with a horizontal polarization (H) or a vertical polarization (V). There may be eight polarization possibilities across these three antenna arrays (e.g., such as HHH, HHV, HVH, HVV, VHH, VHV, VVH and VVV).

The fourth antenna module 1020 may include 2×2, 2×1, and 1×2 antenna arrays with an optimal and unconstrained polarization (e.g., HVV polarization combination of the three antenna arrays, which may have a best performance among the eight polarization possibilities). In some cases, an RFIC feedline mapping may constraint in terms of what polarizations can be combined for these three antenna arrays of the fourth antenna module 1020.

The fifth antenna module 1025 may include 2×2, 2×1, and 1×2 antenna arrays with a fixed polarization (e.g., HHV polarization combination of the three antenna arrays of the fifth antenna module 1025).

As depicted in FIG. 10, performance of double L shaped antenna module with a fixed polarization of its antenna elements and/or antenna arrays is similar to a double L shaped antenna module with an optimal and unconstrained polarization of its antenna elements and/or antenna arrays. For example, the array gain of the fourth antenna module 1020 is similar to the array gain of the fifth antenna module 1025 (e.g., at least over top 30 percent of a sphere).

In some cases, a UE may use any antenna module (e.g., the double L shaped antenna module providing higher array gains due to its capability to steer energy in multiple boresight directions) since it is UE implementation function, and may not notify a gNodeB (gNB) about its antenna modules. In such cases, the gNB may allocate and configure a fixed number of reference signals (RSs) or beams for the UE for beamforming. The gNB may determine the fixed number of RSs to be allocated to the UE, based on a static codebook (e.g., which may be stored in an RFIC memory of the UE). When the allocation of the RSs to the UE is not based on the antenna modules of the UE, an array gain corresponding to the antenna modules of the UE may be low. For example, a high array gain based on combining signals across multiple sides of the double L shaped antenna module cannot be realized by the fixed number of RSs from the static codebook (e.g., as there may be a need for adaptive/dynamic beam weights to combine the signals across the multiple sides of the double L shaped antenna module). The low array gain may result in a lower signal strength (e.g., reference signal received power (RSRP)), which may decrease communication reliability between the UE and the gNB.

### Aspects Related to Reference Signal (RS) Grant Based on Antenna Module Capability With Multiple Boresight Directions

Aspects of the present disclosure provide apparatuses, methods, processing systems, and computer-readable mediums for managing grant of reference signals (RSs) or beams for beamforming.

Techniques proposed herein may enable a gNodeB (gNB) to dynamically allocate and configure RSs for a user equipment (UE) to help enhance beamformed communications based on antenna information regarding antenna modules of the UE. For example, the UE may transmit the antenna information indicating capability of the UE on simultaneous steerability of energy in multiple boresight directions. The antenna information may include a number of boresight directions (e.g., associated with each antenna module of the UE) as well as their relative orientations. Based on the antenna information, the gNB configures and grants UE-specific RSs for adaptive and/or dynamic beam weight learning to enable combining of signals across some or all antenna elements across different boresight directions. This may enhance array gain performance of the antenna modules (e.g., in both no blockage and blockage modes of operation).

The techniques proposed herein may lead to a higher array gain corresponding to the different antenna modules for the UE. The higher array gain may result in a higher signal strength, which may increase communication reliability.

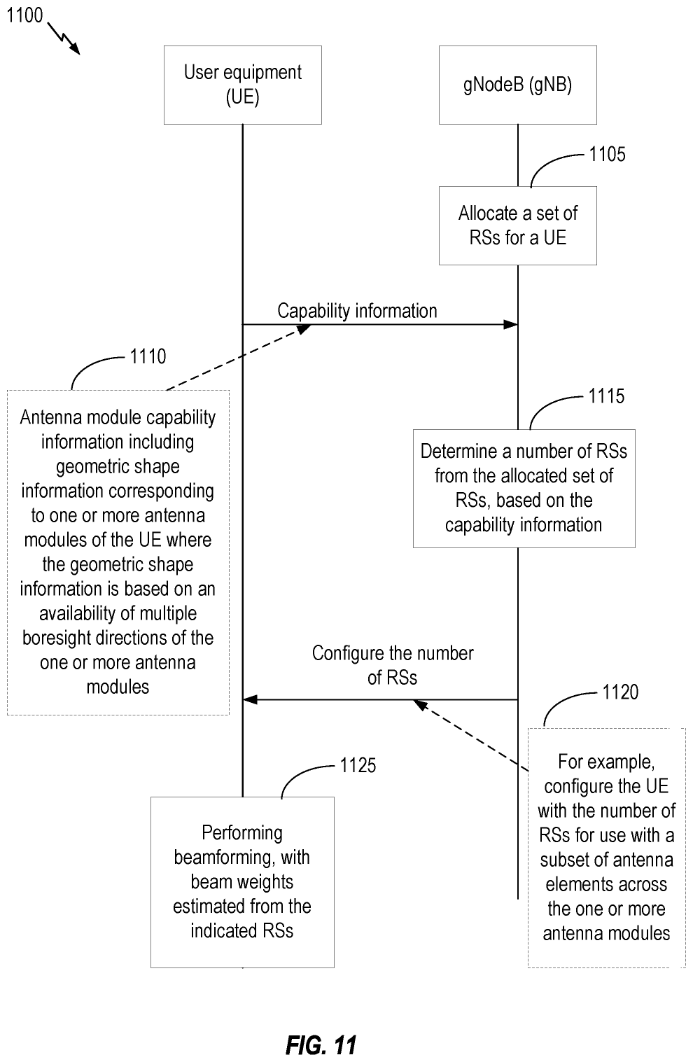

The techniques proposed herein for managing the grant of the RSs may be understood with reference to FIG. 11-FIG. 15.

FIG. 11 depicts a call flow diagram 1100 illustrating example communication among a UE and a network entity (e.g., a gNB) for managing grant of RSs for beamforming. The UE shown in FIG. 11 may be an example of the UE 104 depicted and described with respect to FIG. 1 and FIG. 3. The gNB depicted in FIG. 11 may be an example of the BS 102 depicted and described with respect to FIG. 1 and FIG. 3, or the disaggregated BS depicted and described with respect to FIG. 2.

As indicated at 1105, the gNB allocates a set of RSs for the UE. The set of RSs may include multiple RSs. The set of RSs may include different types of RSs. The gNB may configure and/or enable some or all RSs from the set of RSs for the UE.

As indicated at 1110, the UE transmits antenna module capability information (e.g., corresponding to simultaneous steerability of energy in multiple boresight directions) to the gNB. In one example, a boresight direction is a direction of a peak gain of an antenna element of an antenna module of the UE. In another example, the boresight direction is the direction of the peak gain of the antenna module of the UE.

In certain aspects, the antenna module capability information may include geometric shape information corresponding to one or more antenna modules of the UE. For example, the one or more antenna modules of the UE may include a first antenna module, a second antenna module, and a third antenna module.

In certain aspects, the first antenna module, the second antenna module, and the third antenna module of the UE may have a same shape. For example, each of these antenna modules may have a L shape. In another example, each of these antenna modules may have a double L shape.

In certain aspects, the first antenna module, the second antenna module, and the third antenna module of the UE may have a different shape with respect to each other. For example, the geometric shape information corresponding to the first antenna module of the UE may indicate a planar antenna module. In another example, the geometric shape information corresponding to the second antenna module of the UE may indicate a L shaped antenna module. In another example, the geometric shape information corresponding to the third antenna module of the UE may indicate a double L shaped antenna module.

In certain aspects, the antenna module capability information may indicate a number of boresight directions of the one or more antenna modules of the UE. Each antenna module may include multiple antenna arrays or antennas, and each antenna array or antenna is associated with a distinct and independent boresight direction. For example, the antenna module capability information may indicate two distinct and independent boresight directions or orthogonal directions of a L shaped antenna module (that includes two antenna arrays) of the UE. In another example, the antenna module capability information may indicate three distinct and independent boresight directions or orthogonal directions of a double L shaped antenna module (that includes three antenna arrays) of the UE.

In certain aspects, the antenna module capability information may indicate relative orientations of the number of boresight directions of the one or more antenna modules. For example, independence of different boresight directions is based on spatial separation of the boresight directions by a threshold separation angle. That is, each boresight direction is separated from another boresight direction by at least the threshold separation angle.

In one example, the antenna module capability information may indicate the relative orientations of each of the two boresight directions of the L shaped antenna module of the UE. For instance, the L shaped antenna module is associated with a first boresight direction and a second boresight direction, and the first boresight direction is separated from the second boresight direction by a separation angle (e.g., 30 degrees).

In another example, the antenna module capability information may indicate the relative orientations of each of the three boresight directions of the double L shaped antenna module of the UE. For example, the double L shaped antenna module is associated with a first boresight direction, a second boresight direction, and a third boresight direction. The first boresight direction is separated from the second boresight direction by a first separation angle (e.g., 25 degrees), and the second boresight direction is separated from the third boresight direction by a second separation angle (e.g., 35 degrees)

In certain aspects, the antenna module capability information may indicate a number of sides of each of the one or more antenna modules. For example, the antenna module capability information may indicate two sides of a first antenna module of the UE. In another example, the antenna module capability information may indicate three sides of a second antenna module of the UE.

In certain aspects, the antenna module capability information may indicate a total number (and active number) of antennas or antenna elements on each side of the number of sides of each of the one or more antenna modules. For example, the antenna module capability information may indicate five antenna elements on a first side of a first antenna module (e.g., with two sides) of the UE and ten antenna elements on a second side of the first antenna module of the UE. In another example, the antenna module capability information may indicate five antenna elements on a first side of a second antenna module (e.g., with three sides) of the UE, ten antenna elements on a second side of the second antenna module of the UE, and fifteen antenna elements on a third side of the second antenna module of the UE.

As indicated at 1115, the gNB determines a number of RSs (e.g., from the allocated set of RSs for the UE) based on some or all of the antenna module capability information.

For example, the gNB may determine the number of RSs based on an active number of antenna elements on each side of the number of sides of each of the one or more antenna modules.

In another example, the gNB may determine the number of RSs based on the number of boresight directions associated with each of the one or more antenna modules.

In another example, the gNB may determine the number of RSs based on the relative orientations of the number of boresight directions of the one or more antenna modules.

In another example, the gNB may determine the number of RSs based on: the active number of antenna elements on each side of the number of sides of each of the one or more antenna modules, the number of boresight directions associated with each of the one or more antenna modules, and the relative orientations of the number of boresight directions of the one or more antenna modules.

As indicated at 1120, the gNB configures the UE with the determined number of RSs (e.g., for use with a subset of antenna elements or all antenna elements across the one or more antenna modules of the UE). For example, the gNB may configure and grant one or more UE-specific RSs to the UE, to enable combining of signals across the subset or all of the antenna elements across the different and distinct boresight directions of the one or more antenna modules of coverage, to enhance antenna array gain (e.g., an array gain performance in both no blockage and blockage modes of operation of an antenna system including the one or more antenna modules of the UE).

In certain aspects, the gNB may select (and indicate to the UE) the subset of antenna elements across the one or more antenna modules according to a fixed polarization combination. In certain aspects, the gNB may select the subset of antenna elements across the one or more antenna modules according to a deterministic polarization combination.

As indicated at 1125, the UE performs beamforming based on the configured RSs. For example, the UE may combine signals across the subset of antenna elements via the RSs enabled/configured by the gNB.

In certain aspects, the UE performs beamforming based on beam weights estimated from the configured RSs. For example, the UE may determine the beam weights for use with the subset of antenna elements of the one or more antenna modules based on the grant of the RSs.

In certain aspects, the UE may dynamically turn on or turn off certain antenna elements of the one or more antenna modules (such as the double L shaped antenna modules) of the UE to save power. In one example, the UE may decide to turn on or turn off certain antenna elements of the one or more antenna modules on its own. In another example, the UE may decide to turn on or turn off certain antenna elements of the one or more antenna modules based on a message from the gNB. The message may indicate the antenna elements to be turned on or turned off by the UE. The UE may include the information about its antenna elements (i.e., turn on, turn off status of its antenna elements) in the antenna module capability information, which is periodically sent to the gNB. The gNB may use the information about the antenna elements of the UE to determine the number of RSs for the UE.

### Example Method for Wireless Communications at a User Equipment (UE)

FIG. 12 shows an example of a method 1200 for wireless communications at a user equipment (UE), such as the UE 104 of FIG. 1 and FIG. 3.

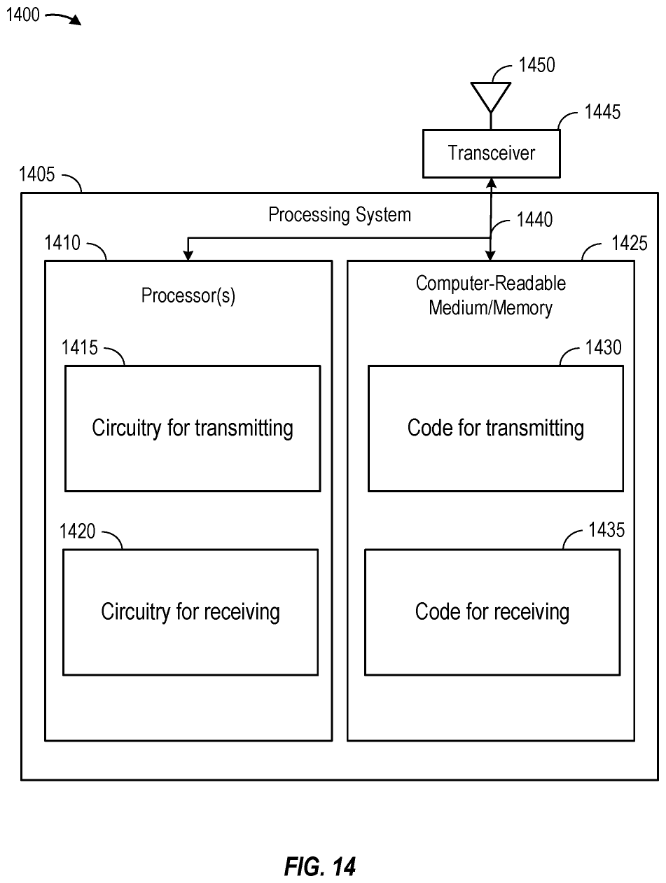

Method 1200 begins at step 1210 with transmitting signaling indicating antenna module capability information comprising geometric shape information corresponding to one or more antenna modules of the UE. The geometric shape information is based on an availability of multiple boresight directions of the one or more antenna modules. In some cases, the operations of this step refer to, or may be performed by, circuitry for transmitting and/or code for transmitting as described with reference to FIG. 14.

Method 1200 then proceeds to step 1220 with receiving an indication of a number of reference signals (RSs). The number of RSs is based on the antenna module capability information. In some cases, the operations of this step refer to, or may be performed by, circuitry for receiving and/or code for receiving as described with reference to FIG. 14.

In certain aspects, the method 1200 further includes performing beamforming, with beam weights estimated from the indicated RSs.

In certain aspects, the antenna module capability information indicates a number of boresight directions of the one or more antenna modules and relative orientations of the number of boresight directions.

In certain aspects, the geometric shape information associated with the one or more antenna modules indicates a number of sides of each of the one or more antenna modules.

In certain aspects, the geometric shape information associated with the one or more antenna modules indicates a number of antenna elements on each side of the number of sides of each of the one or more antenna modules.

In certain aspects, the number of RSs is based on the number of antenna elements on each side of the number of sides of each of the one or more antenna modules.

In certain aspects, the method 1200 further includes receiving a configuration indicating a grant of RSs for use with a subset of antenna elements across one or more antenna modules.

In certain aspects, the method 1200 further includes determining beam weights for use with the one or more antenna modules based on the grant of the RSs.

In certain aspects, the subset of antenna elements combined across the one or more antenna modules are selected according to a fixed or deterministic polarization combination.

In one aspect, the method 1200, or any aspect related to it, may be performed by an apparatus, such as a communications device 1400 of FIG. 14, which includes various components operable, configured, or adapted to perform the method 1200. The communications device 1400 is described below in further detail.

Note that FIG. 12 is just one example of a method, and other methods including fewer, additional, or alternative steps are possible consistent with this disclosure.

### Example Method for Wireless Communications at a Network Entity

FIG. 13 shows an example of a method 1300 for wireless communications at a network entity, such as the BS 102 of FIG. 1 and FIG. 3.

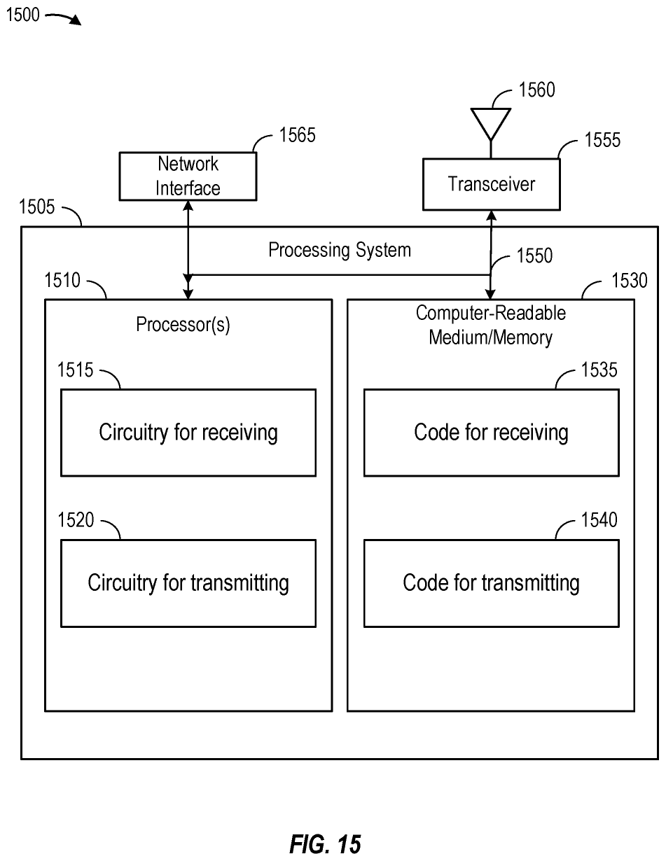

Method 1300 begins at step 1310 with receiving signaling indicating antenna module capability information comprising geometric shape information corresponding to one or more antenna modules of a user equipment (UE). The geometric shape information is based on an availability of multiple boresight directions of the one or more antenna modules. In some cases, the operations of this step refer to, or may be performed by, circuitry for receiving and/or code for receiving as described with reference to FIG. 15.

Method 1300 then proceeds to step 1320 with transmitting an indication of a number of reference signals (RSs). The number of RSs is based on the antenna module capability information. In some cases, the operations of this step refer to, or may be performed by, circuitry for transmitting and/or code for transmitting as described with reference to FIG. 15.

In certain aspects, the antenna module capability information indicates a number of boresight directions of the one or more antenna modules and relative orientations of the number of boresight directions.

In certain aspects, the geometric shape information associated with the one or more antenna modules indicates a number of sides of each of the one or more antenna modules.

In certain aspects, the geometric shape information associated with the one or more antenna modules indicates a number of antenna elements on each side of the number of sides of each of the one or more antenna modules.

In certain aspects, the number of RSs is based on the number of antenna elements on each side of the number of sides of each of the one or more antenna modules.

In certain aspects, the method 1300 further includes transmitting a configuration indicating a grant of RSs for use with a subset of antenna elements across one or more antenna modules.

In one aspect, the method 1300, or any aspect related to it, may be performed by an apparatus, such as a communications device 1500 of FIG. 15, which includes various components operable, configured, or adapted to perform the method 1300. The communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment (UE), such as UE 104 described above with respect to FIG. 1 and FIG. 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, cause the one or more processors 1410 to perform the method 1200 described with respect to FIG. 12, and/or any aspect related to it. Note that reference to a processor performing a function of communications device 1400 may include the one or more processors 1410 performing that function of communications device 1400.

In the depicted example, computer-readable medium/memory 1425 stores code (e.g., executable instructions), such as code for transmitting 1430 and code for receiving 1435. Processing of the code for transmitting 1430 and the code for receiving 1435 may cause the communications device 1400 to perform the method 1200 described with respect to FIG. 12, and/or any aspect related to it.

The one or more processors 1410 include circuitry configured to implement (e.g., execute) the code stored in the computer-readable medium/memory 1425, including circuitry such as circuitry for transmitting 1415 and circuitry for receiving 1420. Processing with the circuitry for transmitting 1415 and the circuitry for receiving 1420 may cause the communications device 1400 to perform the method 1200 described with respect to FIG. 12, and/or any aspect related to it.

Various components of the communications device 1400 may provide means for performing the method 1200 described with respect to FIG. 12, and/or any aspect related to it. For example, means for transmitting, sending or outputting for transmission may include transceivers 354 and/or antenna(s) 352 of the UE 104 illustrated in FIG. 3 and/or the code for transmitting 1430, the circuitry for transmitting 1415, the transceiver 1445 and the antenna 1450 of the communications device 1400 in FIG. 14. Means for receiving or obtaining may include transceivers 354 and/or antenna(s) 352 of the UE 104 illustrated in FIG. 3 and/or the code for receiving 1435, the circuitry for receiving 1420, the transceiver 1445 and the antenna 1450 of the communications device 1400 in FIG. 14.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 14 is an example, and many other examples and configurations of communication device 1400 are possible.

FIG. 15 depicts aspects of an example communications device 1500. In some aspects, communications device 1500 is a network entity, such as BS 102 of FIG. 1 and FIG. 3, or a disaggregated base station as discussed with respect to FIG. 2.

The communications device 1500 includes a processing system 1505 coupled to a transceiver 1555 (e.g., a transmitter and/or a receiver) and/or a network interface 1565. The transceiver 1555 is configured to transmit and receive signals for the communications device 1500 via an antenna 1560, such as the various signals as described herein. The network interface 1565 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include the one or more processors 1510 of communications device 1500 performing that function.

In the depicted example, the computer-readable medium/memory 1530 stores code (e.g., executable instructions), such as code for receiving 1535 and code for transmitting 1540. Processing of the code for receiving 1535 and the code for transmitting 1540 may cause the communications device 1500 to perform the method 1300 described with respect to FIG. 13, or any aspect related to it.

The one or more processors 1510 include circuitry configured to implement (e.g., execute) the code stored in the computer-readable medium/memory 1530, including circuitry such as circuitry for receiving 1515 and circuitry for transmitting 1520. Processing with the circuitry for receiving 1515 and the circuitry for transmitting 1520 may cause the communications device 1500 to perform the method 1300 described with respect to FIG. 13, or any aspect related to it.

Various components of the communications device 1500 may provide means for performing the method 1300 described with respect to FIG. 13, or any aspect related to it. Means for transmitting, sending or outputting for transmission may include transceivers 332 and/or antenna(s) 334 of the BS 102 illustrated in FIG. 3 and/or the circuitry for transmitting 1520, the code for transmitting 1540, the transceiver 1555 and the antenna 1560 of the communications device 1500 in FIG. 15. Means for receiving or obtaining may include transceivers 332 and/or antenna(s) 334 of the BS 102 illustrated in FIG. 3 and/or the circuitry for receiving 1515, the code for receiving 1535, the transceiver 1555 and the antenna 1560 of the communications device 1500 in FIG. 15.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 15 is an example, and many other examples and configurations of communication device 1500 are possible.

### EXAMPLE CLAUSES

Implementation examples are described in the following numbered clauses:

Clause 1: A method for wireless communications at a user equipment (UE), comprising: transmitting signaling indicating antenna module capability information comprising geometric shape information corresponding to one or more antenna modules of the UE, wherein the geometric shape information is based on an availability of multiple boresight directions of the one or more antenna modules; and receiving an indication of a number of reference signals (RSs), wherein the number of RSs is based on the antenna module capability information.

Clause 2: The method of clause 1, further comprising performing beamforming, with beam weights estimated from the indicated RSs.

Clause 3: The method of any one of clauses 1-2, wherein the antenna module capability information indicates a number of boresight directions of the one or more antenna modules and relative orientations of the number of boresight directions.

Clause 4: The method of any one of clauses 1-3, wherein the geometric shape information associated with the one or more antenna modules indicates a number of sides of each of the one or more antenna modules.

Clause 5: The method of clause 4, wherein the geometric shape information associated with the one or more antenna modules indicates a number of antenna elements on each side of the number of sides of each of the one or more antenna modules.

Clause 6: The method of clause 5, wherein the number of RSs is based on the number of antenna elements on each side of the number of sides of each of the one or more antenna modules.

Clause 7: The method of any one of clauses 1-6, further comprising receiving a configuration indicating a grant of RSs for use with a subset of antenna elements across one or more antenna modules.

Clause 8: The method of clause 7, further comprising determining beam weights for use with the one or more antenna modules based on the grant of the RSs.

Clause 9: The method of clause 7, wherein the subset of antenna elements combined across the one or more antenna modules are selected according to a fixed or deterministic polarization combination.

Clause 10: A method for wireless communications at a network entity, comprising: receiving signaling indicating antenna module capability information comprising geometric shape information corresponding to one or more antenna modules of a user equipment (UE), wherein the geometric shape information is based on an availability of multiple boresight directions of the one or more antenna modules; and transmitting an indication of a number of reference signals (RSs), wherein the number of RSs is based on the antenna module capability information.

Clause 11: The method of clause 10, wherein the antenna module capability information indicates a number of boresight directions of the one or more antenna modules and relative orientations of the number of boresight directions.

Clause 12: The method of any one of clauses 10-11, wherein the geometric shape information associated with the one or more antenna modules indicates a number of sides of each of the one or more antenna modules.

Clause 13: The method of clause 12, wherein the geometric shape information associated with the one or more antenna modules indicates a number of antenna elements on each side of the number of sides of each of the one or more antenna modules.

Clause 14: The method of clause 13, wherein the number of RSs is based on the number of antenna elements on each side of the number of sides of each of the one or more antenna modules.

Clause 15: The method of any one of clauses 10-14, further comprising transmitting a configuration indicating a grant of RSs for use with a subset of antenna elements across one or more antenna modules.

Clause 16: An apparatus, comprising: a memory comprising executable instructions; and one or more processors configured, individually or in any combination, to execute the executable instructions and cause the apparatus to perform a method in accordance with any one of Clauses 1-15.

Clause 17: An apparatus, comprising means for performing a method in accordance with any one of Clauses 1-15.

Clause 18: A non-transitory computer-readable medium comprising executable instructions that, when executed by one or more processors of an apparatus, cause the apparatus to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
a memory comprising instructions; and
one or more processors configured, individually or in any combination, to execute the instructions and cause the apparatus to:
transmit signaling indicating antenna module capability information comprising geometric shape information corresponding to one or more antenna modules of the UE, wherein the geometric shape information is based on an availability of multiple boresight directions of the one or more antenna modules; and
receive an indication of a number of reference signals (RSs), wherein the number of RSs is based on the antenna module capability information.

2. The apparatus of claim 1, wherein the one or more processors are further configured, individually or in any combination, to execute the instructions and cause the apparatus to perform beamforming, with beam weights estimated from the indicated RSs.

3. The apparatus of claim 1, wherein the antenna module capability information indicates a number of boresight directions of the one or more antenna modules and relative orientations of the number of boresight directions.

4. The apparatus of claim 1, wherein the geometric shape information associated with the one or more antenna modules indicates a number of sides of each of the one or more antenna modules.

5. The apparatus of claim 4, wherein the geometric shape information associated with the one or more antenna modules indicates a number of antenna elements on each side of the number of sides of each of the one or more antenna modules.

6. The apparatus of claim 5, wherein the number of RSs is based on the number of antenna elements on each side of the number of sides of each of the one or more antenna modules.

7. The apparatus of claim 1, wherein the one or more processors are further configured, individually or in any combination, to execute the instructions and cause the apparatus to receive a configuration indicating a grant of RSs for use with a subset of antenna elements across one or more antenna modules.

8. The apparatus of claim 7, wherein the one or more processors are further configured, individually or in any combination, to execute the instructions and cause the apparatus to determine beam weights for use with the one or more antenna modules based on the grant of the RSs.

9. The apparatus of claim 7, wherein the subset of antenna elements combined across the one or more antenna modules are selected according to a fixed or deterministic polarization combination.

10. An apparatus for wireless communications at a network entity, comprising:
a memory comprising instructions; and
one or more processors configured, individually or in any combination, to execute the instructions and cause the apparatus to:
receive signaling indicating antenna module capability information comprising geometric shape information corresponding to one or more antenna modules of a user equipment (UE), wherein the geometric shape information is based on an availability of multiple boresight directions of the one or more antenna modules; and
transmit an indication of a number of reference signals (RSs), wherein the number of RSs is based on the antenna module capability information.

11. The apparatus of claim 10, wherein the antenna module capability information indicates a number of boresight directions of the one or more antenna modules and relative orientations of the number of boresight directions.

12. The apparatus of claim 10, wherein the geometric shape information associated with the one or more antenna modules indicates a number of sides of each of the one or more antenna modules.

13. The apparatus of claim 12, wherein the geometric shape information associated with the one or more antenna modules indicates a number of antenna elements on each side of the number of sides of each of the one or more antenna modules.

14. The apparatus of claim 13, wherein the number of RSs is based on the number of antenna elements on each side of the number of sides of each of the one or more antenna modules.

15. The apparatus of claim 10, wherein the one or more processors are further configured, individually or in any combination, to execute the instructions and cause the apparatus to transmit a configuration indicating a grant of RSs for use with a subset of antenna elements across one or more antenna modules.

16. A method for wireless communications at a user equipment (UE), comprising:
transmitting signaling indicating antenna module capability information comprising geometric shape information corresponding to one or more antenna modules of the UE, wherein the geometric shape information is based on an availability of multiple boresight directions of the one or more antenna modules; and
receiving an indication of a number of reference signals (RSs), wherein the number of RSs is based on the antenna module capability information.

17. The method of claim 16, further comprising performing beamforming, with beam weights estimated from the indicated RSs.

18. The method of claim 16, wherein the antenna module capability information indicates a number of boresight directions of the one or more antenna modules and relative orientations of the number of boresight directions.

19. The method of claim 16, wherein the geometric shape information associated with the one or more antenna modules indicates a number of sides of each of the one or more antenna modules.

20. The method of claim 19, wherein the geometric shape information associated with the one or more antenna modules indicates a number of antenna elements on each side of the number of sides of each of the one or more antenna modules.

21. The method of claim 20, wherein the number of RSs is based on the number of antenna elements on each side of the number of sides of each of the one or more antenna modules.

22. The method of claim 16, further comprising receiving a configuration indicating a grant of RSs for use with a subset of antenna elements across one or more antenna modules.

23. The method of claim 22, further comprising determining beam weights for use with the one or more antenna modules based on the grant of the RSs.

24. The method of claim 22, wherein the subset of antenna elements combined across the one or more antenna modules are selected according to a fixed or deterministic polarization combination.

25. A method for wireless communications at a network entity, comprising:
receiving signaling indicating antenna module capability information comprising geometric shape information corresponding to one or more antenna modules of a user equipment (UE), wherein the geometric shape information is based on an availability of multiple boresight directions of the one or more antenna modules; and
transmitting an indication of a number of reference signals (RSs), wherein the number of RSs is based on the antenna module capability information.

26. The method of claim 25, wherein the antenna module capability information indicates a number of boresight directions of the one or more antenna modules and relative orientations of the number of boresight directions.

27. The method of claim 25, wherein the geometric shape information associated with the one or more antenna modules indicates a number of sides of each of the one or more antenna modules.

28. The method of claim 27, wherein the geometric shape information associated with the one or more antenna modules indicates a number of antenna elements on each side of the number of sides of each of the one or more antenna modules.

29. The method of claim 28, wherein the number of RSs is based on the number of antenna elements on each side of the number of sides of each of the one or more antenna modules.

30. The method of claim 25, further comprising transmitting a configuration indicating a grant of RSs for use with a subset of antenna elements across one or more antenna modules.
